(19) United States
(12) Patent Application Publication
(10) Pub. No.: US 2016/0117410 A1
(43) Pub. Date: Apr. 28, 2016

(54) EXI FORMAT TO REPRESENT JSON DOCUMENTS

(71) Applicant: FUJITSU LIMITED, Kawasaki-shi (JP)

(72) Inventor: Takuki KAMIYA, Palo Alto, CA (US)

(21) Appl. No.: 14/522,465

(22) Filed: Oct. 23, 2014

(51) Int. Cl. G06F 17/30

(52) U.S. Cl. CPC G06F 17/30896; G06F 17/30905

(57) ABSTRACT

A method of encoding an Efficient XML Interchange (EXI) document to represent a JavaScript Object Notation (JSON) document without use of a binary-type JSON representation solution may include fetching a set of tokens associated with the JSON document. The method may also include determining one or more terminal types associated with the set of tokens. The method may also include determining one or more current names and one or more current distances for the set of tokens based in part on the terminal type for the tokens in the set. The method may also include encoding an EXI document representing the JSON document based on the one or more current names and the one or more current distances for the set of tokens associated with the JSON document.

### FIELD

The embodiments discussed herein are related to Efficient XML Interchange (EXI) format to represent JavaScript Object Notation (JSON) documents.

### BACKGROUND

Extensible Markup Language (XML) is a markup language that defines a set of rules for encoding documents in a plain-text format that is both human-readable and machine-readable. One version of XML is defined in the XML 1.0 Specification produced by the World Wide Web Consortium (W3C) and dated Nov. 26, 2008, which is incorporated herein by reference in its entirety. The XML 1.0 Specification defines an XML document as a text that is well-formed and valid.

An XML schema is a description of a type of XML document, typically expressed in terms of constraints on the structure and content of documents of that type, above and beyond the basic syntactical constraints imposed by the XML 1.0 Specification itself. These constraints are generally expressed using some combination of grammatical rules governing the order of elements, boolean predicates associated with the content, data types governing the content of elements and attributes, and more specialized rules such as uniqueness and referential integrity constraints. The process of checking to see if an XML document conforms to an XML schema is called validation, which is separate from XML's core concept of syntactic well-formedness. All XML documents are defined as being well-formed, but an XML document is on check for validity where the XML processor is “validating,” in which case the XML document is checked for conformance with its associated schema.

Although the plain-text human-readable aspect of XML documents may be beneficial in many situations, this human-readable aspect may also lead to XML documents that are large in size and therefore incompatible with devices with limited memory or storage capacity. Efforts to reduce the size of XML documents have therefore often eliminated this plain-text human-readable aspect in favor of more compact binary representations.

EXI is a Binary XML format in which XML documents are encoded in a binary data format rather than plain text. In general, using a binary XML format reduces the size and verbosity of XML documents, and may reduce the cost in terms of time and effort involved in parsing XML documents. EXI is formally defined in the EXI Format 1.0 Specification produced by the W3C and dated Mar. 10, 2011, which is incorporated herein by reference in its entirety. An XML document may be encoded in an EXI format as a separate EXI stream.

When no schema information is available or when available schema information describes only portions of an EXI stream, EXI employs built-in element grammars. Built-in element grammars are dynamic and continuously evolve to reflect knowledge learned while processing an EXI stream. New built-in element grammars are created to describe the content of newly encountered elements and new grammar productions are added to refine existing built-in grammars. Newly learned grammars and productions are used to more efficiently represent subsequent elements in the EXI stream.

JSON is a lightweight data interchange format. JSON may be growing in popularity in part because it is considered to be easy to read and write for humans. JSON is a text format independent of any language but uses conventions that may be considered to be familiar with the languages descended from C, such as C, C++, C#, Java, JavaScript, Perl, Python, and others. JSON may be considered a data exchange language in part because of the overlap of conventions with languages descended from C.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of encoding an Efficient XML Interchange (EXI) document to represent a JavaScript Object Notation (JSON) document without use of a binary-type JSON representation solution may include fetching a set of tokens associated with the JSON document. The method may also include determining one or more terminal types associated with the set of tokens. The method may also include determining one or more current names and one or more current distances for the set of tokens based in part on the terminal type for the tokens in the set. The method may also include encoding an EXI document representing the JSON document based on the one or more current names and the one or more current distances for the set of tokens associated with the JSON document.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A and 1B are block diagrams of an example JavaScript Object Notation (JSON) representation system;

FIG. 2 illustrates an example built-in element grammar for Efficient XML Interchange (EXI);

FIG. 3 illustrates an example built-in element grammar for EXI before and after invocation;

FIG. 4 is a block diagram of an example of an EXI grammar;

FIG. 5 is a block diagram of an example of an object grammar for representing JSON objects in EXI;

FIG. 6 is a block diagram of an example of an array grammar for representing JSON arrays in EXI;

FIG. 7 is a block diagram of an example of a document grammar for representing JSON documents in EXI;

FIGS. 8A-8C are block diagrams of an example method of determining a current name and a current distance;

FIG. 9A is a block diagram of an example method of determining a string-value partition and a value channel;

FIG. 9B is a block diagram of an example system of determining a string-value partition and a value channel;

FIG. 10A is a block diagram of an example method of determining an effective name and an effective distance;

FIG. 10B is a block diagram of an example system of determining an object grammar and an array grammar;

FIG. 11 is a block diagram of an example method of providing an object grammar self-calibration; and

FIG. 12 is a block diagram of an example method of providing an array grammar self-calibration.

### DESCRIPTION OF EMBODIMENTS

The embodiments discussed herein are related to Efficient XML Interchange (EXI) format to represent JavaScript Object Notation (JSON) documents. EXI format may be designed to efficiently represent structured documents. The EXI format may be described by the Efficient XML Interchange (EXI) Format 1.0 (Second Edition) produced by the W3C and dated Feb. 11, 2014, which is incorporated herein by reference in its entirety. One or more EXI processors may be modified according to the techniques described herein and used to encode an EXI document to represent any JavaScript Object Notation (JSON) document, resulting in an improvement over representing JSON documents using binary-type JSON representation solutions both in terms of compactness and processing efficiency, among potentially other metrics. An example binary-type JSON representation solution includes Concise Binary Object Representation (CBOR).

Embodiments of the present invention will be explained with reference to the accompanying drawings.

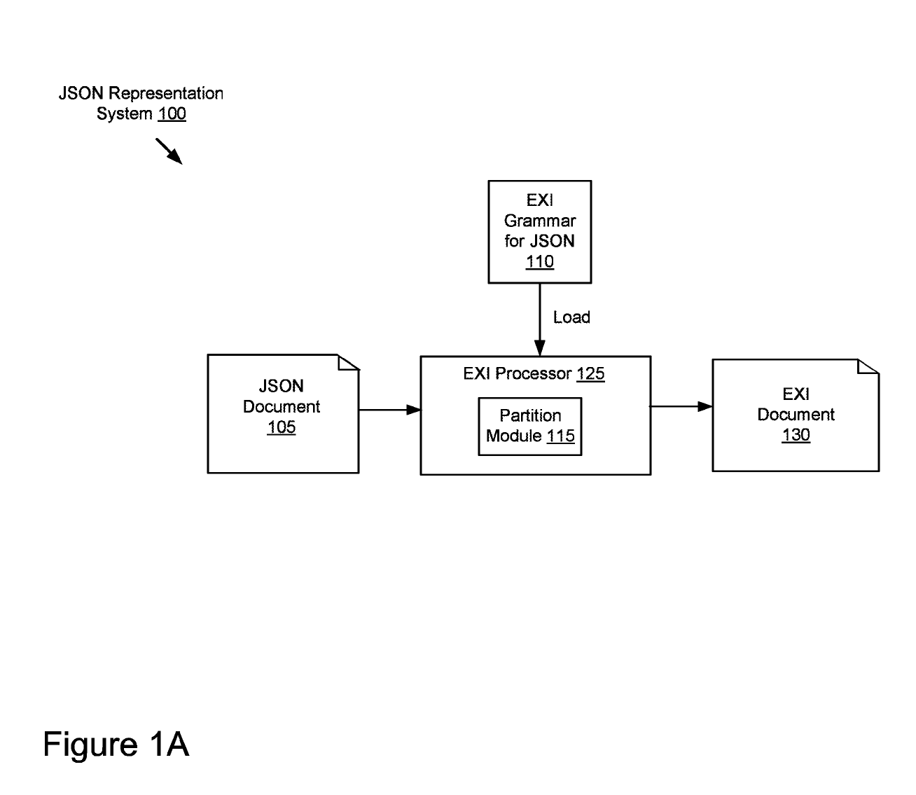

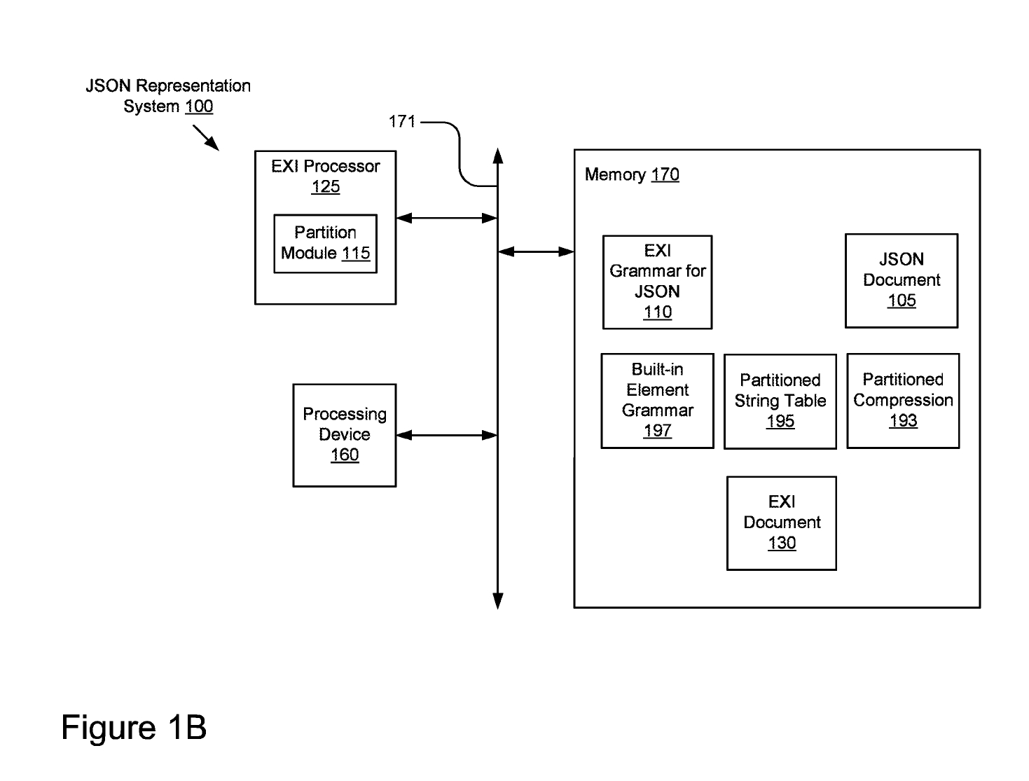

FIG. 1A is a block diagram of an example JSON representation system 100, arranged in accordance with at least some embodiments described herein. The JSON representation system 100 may be implemented as a component of a processor-based computing device. For example, the JSON representation system 100 may include one or more components of a tablet computer, a laptop computer, a desktop computer, a mainframe, or any other processor-based computing device.

The JSON representation system 100 may include a JSON document 105, an EXI grammar for JSON 110 (herein referred to as “EXI grammar 110”), an EXI processor 125, and an EXI document 130 representing the JSON document 105. The EXI processor 125 may include a partition module 115.

The JSON document 105 may include any document written or encoded in the JSON format. The EXI document 130 may include any document written or encoded in the EXI format which represents the JSON document 105. The EXI document 130 may be or include an EXI stream. The EXI processor 125 may include code and routines configured to analyze a JSON document and encode an EXI document representing the JSON document. For example, the EXI processor 125 receives the JSON document 105 as an input and outputs the EXI document 130 representing the JSON document 105. Alternately, the EXI processor 125 may be implemented in hardware or may include a combination of hardware and code and/or routines.

In one embodiment, the EXI processor 125 includes the partition module 115 or the EXI grammar 110. The EXI processor 125 may also include one or more EXI encoders, EXI decoders, or other EXI codes and routines configured to provide the functionality of the EXI processor 125. Examples of EXI processors, EXI encoders, EXI decoders, and other EXI codes and routines may be described in the Efficient XML Interchange (EXI) Format 1.0 (Second Edition), which is incorporated by reference in its entirety.

The EXI processor 125 may include support for JSON inputs or JSON outputs, or for both JSON inputs and JSON outputs. The EXI processor 125 may be configured to encode the EXI document 130 representing the JSON document 105 without use of a binary-type JSON representation solution. For example, the EXI processor 125 may be configured to encode the EXI document 130 representing the JSON document 105 without use of Concise Binary Object Representation (CBOR) or the GZip file format for compaction of the JSON document 105. The partition module 115 and the EXI grammar 110 will now be described according to some embodiments.

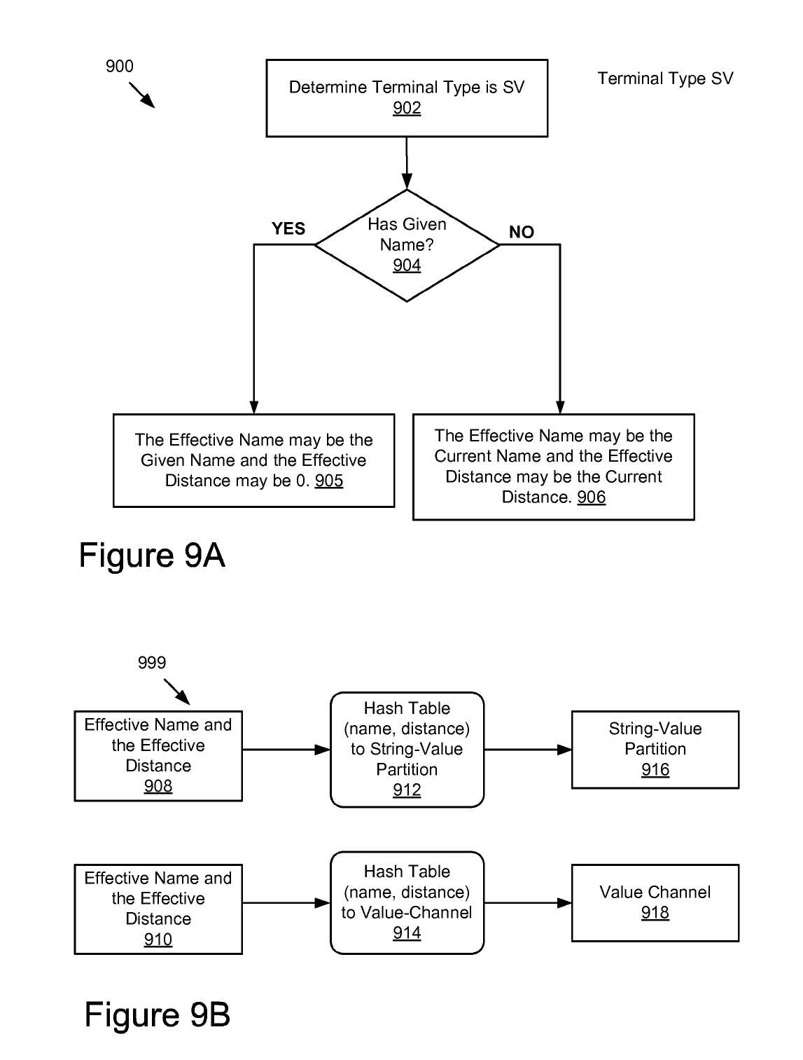

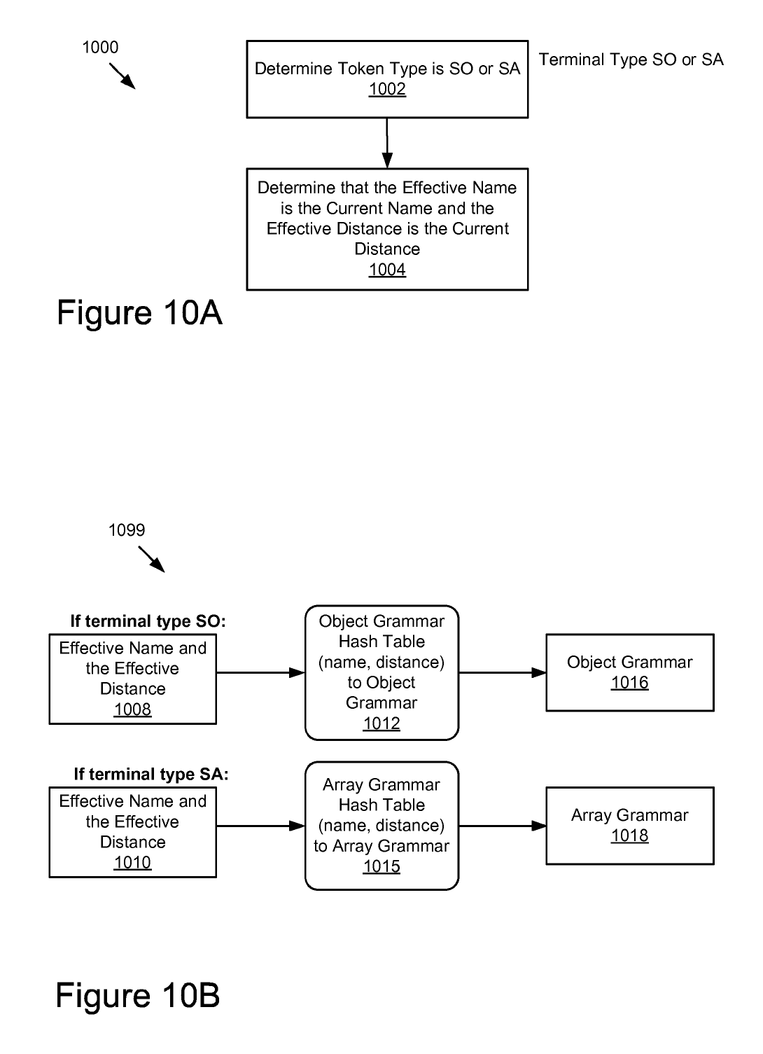

The partition module 115 may include code and routines configured to analyze a JSON document and partition one or more elements of the JSON document based on a distance from a named object. For example, the partition module 115 may partition one or more objects of the JSON document 105 using a distance from a named object to determine an object grammar 1016 as described below with reference to FIG. 10B. The partition module 115 may also partition one or more arrays of the JSON document 105 using a distance from a named object to determine an array grammar 1018 as described below with reference to FIG. 10B. The partition module 115 may also determine a string-value partition 916 or a value channel 918 as described below with reference to FIG. 9B. In some embodiments, the JSON representation system 100 may encode the EXI document 130 describing the JSON document 105 based on one or more of the: JSON document 105; EXI grammar 110; object grammar 1016; array grammar 1018; string-value partition 916; or value channel 918.

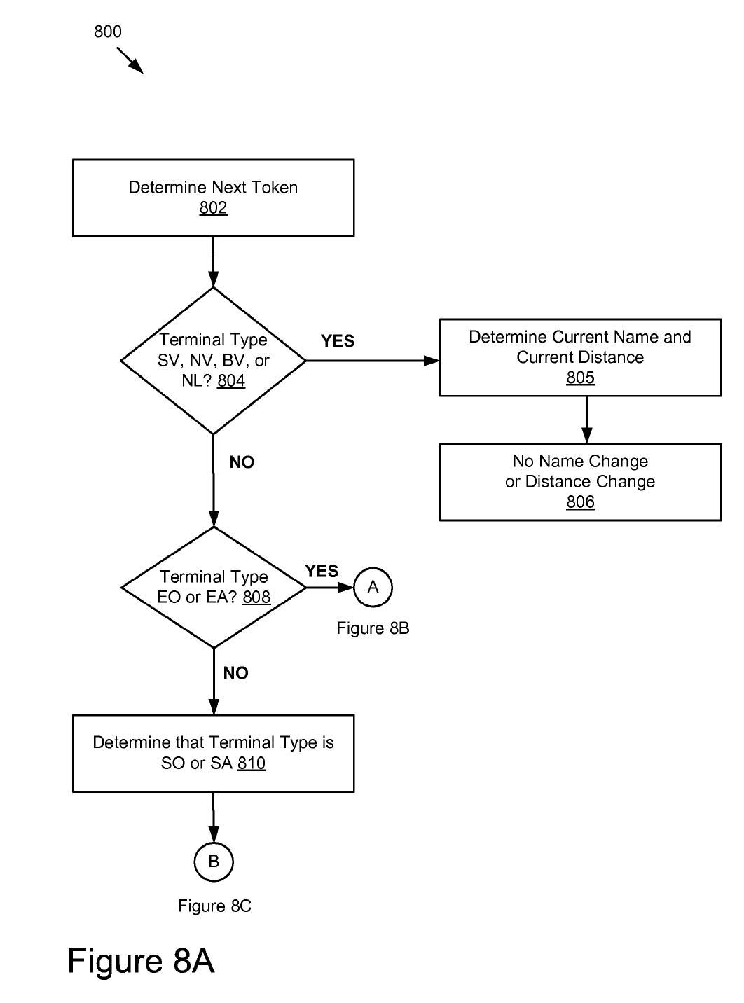

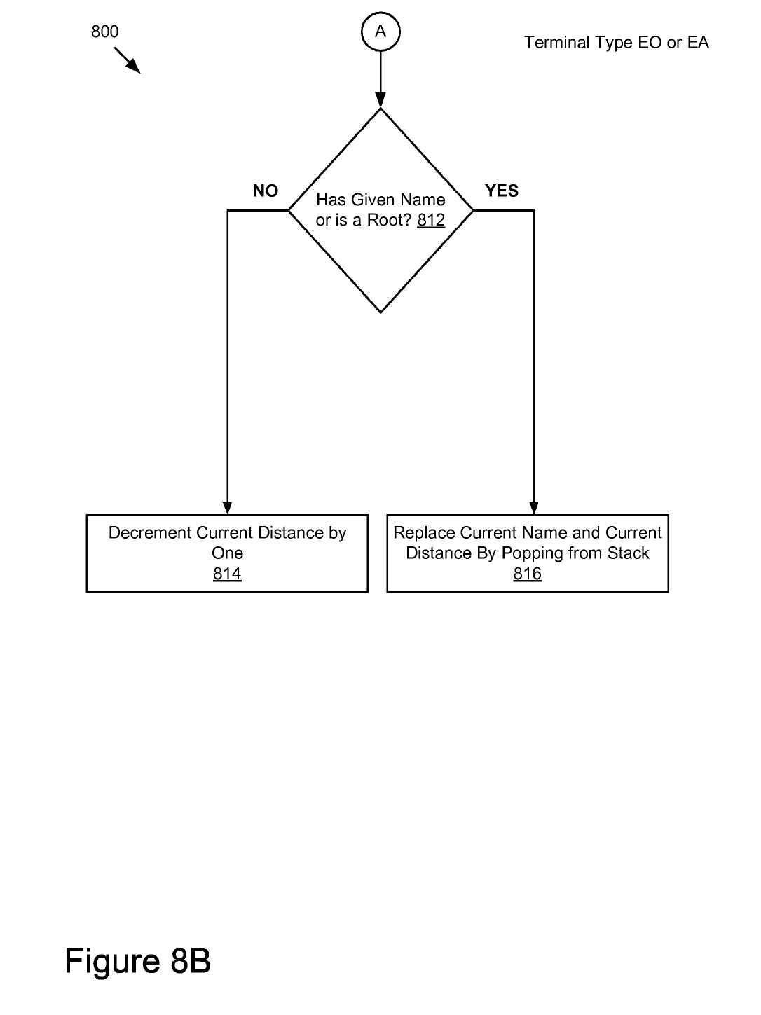

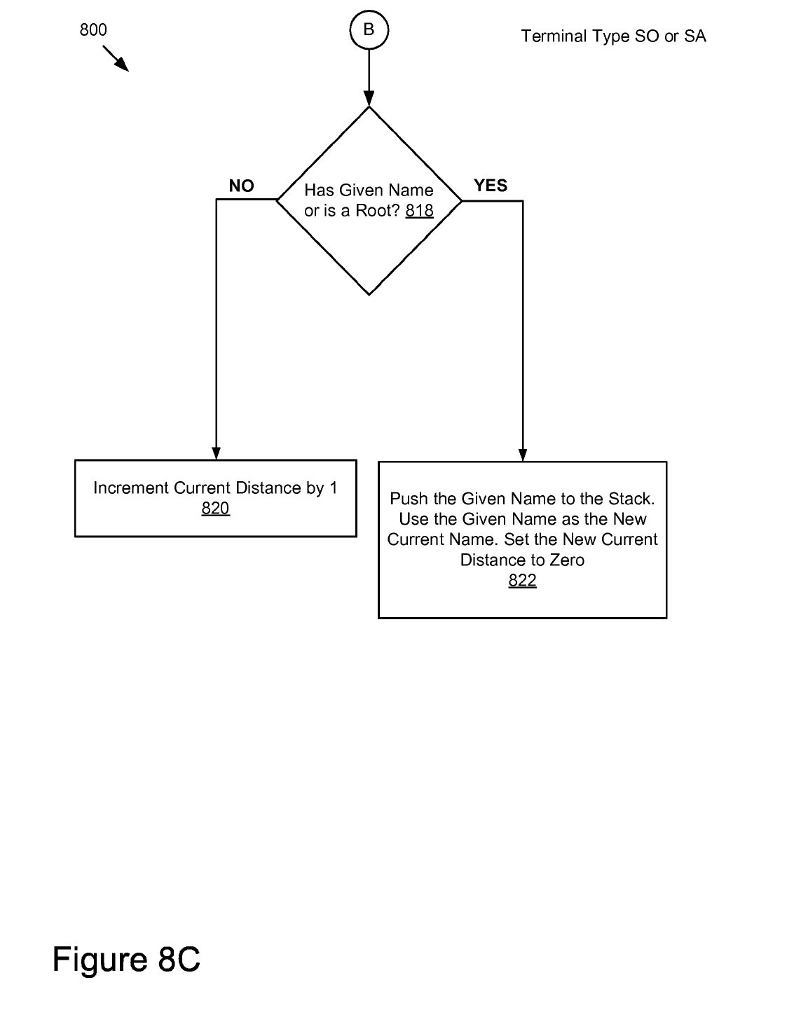

In one embodiment, the EXI processor 125 or the partition module 115 may include code and routines configured to perform one or more blocks of methods 800, 900, 1000, 1100, 1200 described below with reference to FIGS. 8A-12 when executed by a processor-based computing device (see FIG. 1B). The partition module 115 will be described in more detail below with reference to FIGS. 1B and 8A-12.

The EXI grammar 110 may include an EXI grammar configured to enable the EXI processor 125 to receive a JSON document as an input and encode the EXI document 130 representing the JSON document 105 as an output. For example, the EXI processor 125 is configured to receive the JSON document 105 and the EXI grammar 110 as an input and encode the EXI document 130 representing the JSON document 105 as an output based on the JSON document 105 and the EXI grammar 110. The EXI processor 125 may load the EXI grammar 110 and analyze the JSON document 105 based on the EXI grammar 110. An example of the EXI grammar 110 is described in more detail below with reference to FIG. 9.

FIG. 1B is a block diagram of the example JSON representation system 100, arranged in accordance with at least one embodiment described herein. The JSON representation system 100 of FIG. 1B is an example embodiment of the JSON representation system 100 described above with reference to FIG. 1A. In some embodiments, the JSON representation system 100 may include a processor-based computing device. For example, the JSON representation system 100 may include a tablet computer, a laptop computer, a desktop computer, mainframe, or any other processor-based computing device. In some embodiments, the JSON representation system 100 may include a special-purpose processor-based computing device configured to execute one or more blocks of the methods 800, 900, 1000, 1100, 1200 described below with reference to FIGS. 8A-12.

The JSON representation system 100 may include the EXI processor 125, a processing device 160, and a memory 170. The various components of the JSON representation system 100 may be communicatively coupled to one another via a bus 171.

The EXI processor 125 may include the partition module 115. The EXI processor 125 and the partition module 115 were described above with reference to FIG. 1A, and their descriptions will not be repeated here.

The processing device 160 may include an arithmetic logic unit, a microprocessor, a general-purpose controller, or some other processor array to perform computations and provide electronic display signals to a display device. The processing device 160 processes data signals and may include various computing architectures including a complex instruction set computer (CISC) architecture, a reduced instruction set computer (RISC) architecture, or an architecture implementing a combination of instruction sets. Although FIG. 1B includes a single processing device 160, multiple processing devices 160 may be included. Other processors, operating systems, sensors, displays, and physical configurations are possible.

In one embodiment, the JSON representation system 100 may include code and routines configured to perform or control performance of one or more blocks of the methods 800, 900, 1000, 1100, 1200 described below with reference to FIGS. 8A-12 when executed by the processing device 160.

The memory 170 may store instructions and/or data that may be executed by the processing device 160. The instructions and/or data may include code for performing the techniques described herein. In some embodiments, the instructions may include instructions and data which cause the processing device 160 to perform a certain function or group of functions.

In some embodiments the memory 170 may include a computer-readable media for carrying or having computer-executable instructions or data structures stored thereon. Such computer-readable media may be any available media that may be accessed by the processing device 160 that may be programmed to execute the computer-executable instructions stored on the computer-readable media. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store desired program code in the form of computer-executable instructions or data structures and which may be accessed by the processing device 160. The memory 170 may be a tangible or non-transitory computer-readable medium storing executable instructions which may be accessed and executed by the processing device 160. Combinations of the above may also be included within the scope of computer-readable media.

In the depicted embodiment, the memory 170 may store the EXI grammar 110, the JSON document 105, the EXI document 130 representing the JSON document 105, a built-in element grammar 197, a partitioned string table 195, and a partitioned compression 193.

Optionally, in some embodiments the memory 170 may store any other data used by the partition module 115 to provide its functionality. For example, the memory 170 may store one or more libraries of standard functions or custom functions. In some embodiments, the memory 170 may store one or more hash tables. For example, the memory 170 may store one or more of hash tables 912, 914, 1012, 1015 described below with reference to FIGS. 9B and 10B. In some embodiments, the EXI processor 125 or the partition module 115 may include code and routines stored on the memory 170 and executed by the processing device 160.

The EXI grammar 110, the JSON document 105, and the EXI document 130 were described above with reference to FIG. 1A, and their descriptions will not be repeated here.

In one embodiment, the built-in element grammar 197, the partitioned string table 195, and the partitioned compression 193 are elements of the EXI document 130 representing the JSON document 105.

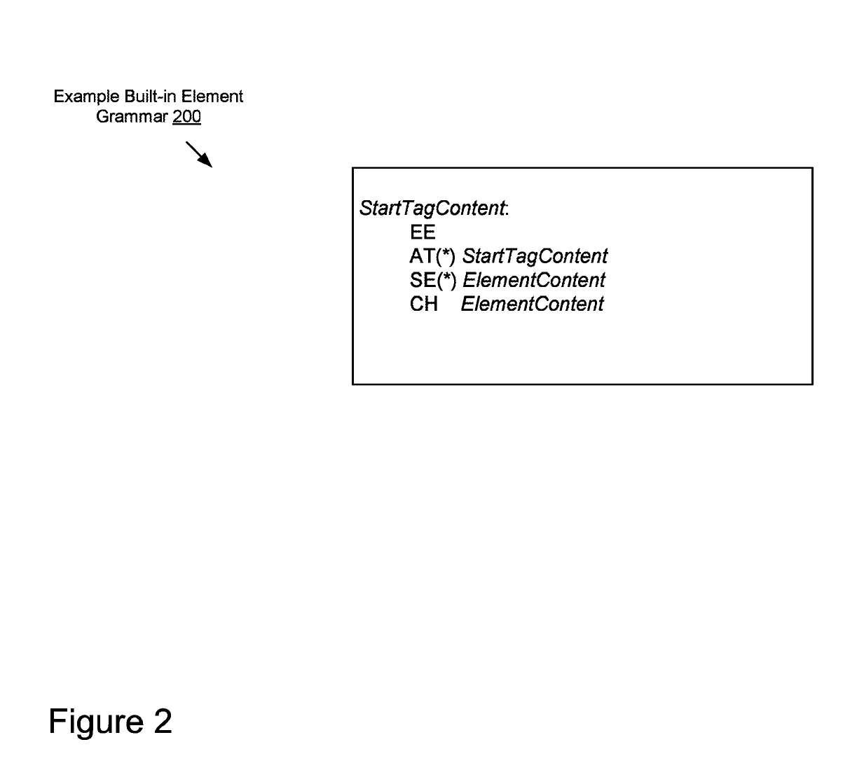

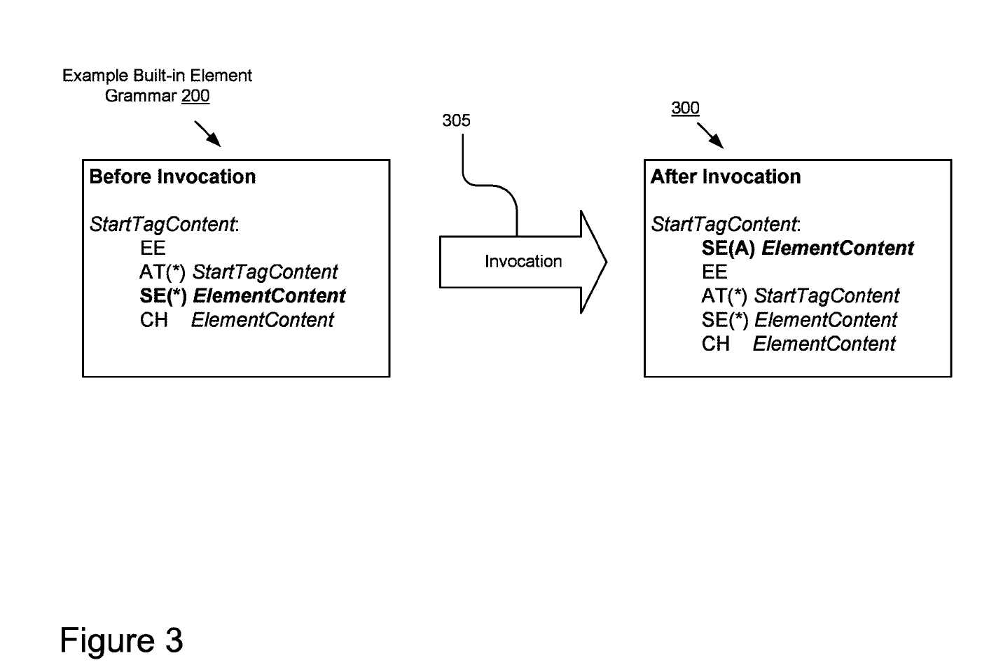

The built-in element grammar 197 may include an EXI built-in element grammar. Examples of the built-in element grammar 197 are described below with reference to FIGS. 2 and 3. The EXI processor 125 may use the built-in element grammar 197 to encode the EXI document 130 representing the JSON document 105.

The partitioned string table 195 may include a string table allowing for representation of one or more string values. For example, the partitioned string table 195 may include a string table including data for representing one or more string values associated with the JSON document 105.

The partitioned compression 193 may include a compression partitioned into a value channel. For example, the partitioned compression may include the compression partitioned into the value channel 918 described below with reference to FIG. 9B. The partitioned compression 193 may include an EXI compression for representing the JSON document 105. In one embodiment, the partitioned compression 193 may include an integrated redundancy-based EXI compression partitioned into one or more EXI compression channels.

In some embodiments, the JSON representation system 100 may encode the EXI document 130 representing the JSON document 105 using one or more of the EXI grammar 110, the built-in element grammar 197, the partitioned string table 195, or the partitioned compression 193.

In some embodiments, the built-in element grammar 197, the partitioned string table 195, and the partitioned compression 193 are partitioned based on one or more names included in the JSON document 105. For example, these elements may be partitioned based on one or more element names or attribute names included in the JSON document 105. In some embodiments, these elements may be partitioned by the partition module 115. The partitioned string table 195 or the partitioned compression 193 may be partitioned using a hash function. An example hash table that may be used for partitioning is described below with reference to elements 912 and 914 of FIG. 9B.

In some embodiments, partitioning the built-in element grammar 197, the partitioned string table 195, and the partitioned compression 193 based on one or more names included in the JSON document 105 may beneficially make each of these elements function more efficiently. For example, partitioning the built-in element grammar 197 based on one or more names included in the JSON document 105 may result in the built-in element grammar 197 having a more precise grammar calibration for each name of the JSON document 105.

In some embodiments, partitioning the string table 195 based on one or more names included in the JSON document 105 may result in smaller index numbers for the partitioned string table 195 versus a non-partitioned string table, thereby resulting in fewer bits and more efficient encoding for representing the JSON document 105.

In some embodiments, partitioning the compression 193 based on one or more names included in the JSON document 105 may result in the same name providing similar data, thereby resulting in a higher compression ratio, higher processing efficiency, and higher amenability to stream the EXI document 130.

In some embodiments, the partition module 115 may divide the JSON document 105, the EXI document 130, or portions of the JSON document 105 or the EXI document 130 into one or more non-overlapping partitions. The EXI processor 125 or the partition module 115 may include functionality to enable a user to edit the JSON document 105 or the EXI document 130. For example, the EXI processor 125 may include a text editor module (not pictured) including code and routines configured to enable the user to edit the JSON document 105, the EXI document 130, or any other document stored on the memory 170 which is described below. As described above, the memory 170 may store other data used by the partition module 115 to provide its functionality, including, for example, one or more libraries of functions (not pictured). The partition module 115 may define one or more explicit partitions for any documents. The partition module 115 may partition a document by associating them with an instance of a partition function stored in one of the libraries of the memory 170. In some embodiments the partition module 115 may partition the document using one or more hash functions or one or more hash tables. The partition function may be an element of the partition module 115.

In some embodiments, the partition function of the partition module 115 may include a partition scanner (not pictured). The partition scanner may include code and routines configured to determine one or more partitions for the JSON document 105. The partition scanner may determine a region of the JSON document 105 and identify a set of one or more tokens describing each of the partitions for that region of the JSON document 105. The partition module 115 may create the EXI document 130 to represent the JSON document 105, and the partition scanner may determine one or more tokens for the EXI document 130 based in part on the set of tokens identified in the JSON document 105 so that the EXI document 130 represents the JSON document 105.

In some embodiments, the partition module 115 may provide its functionality based in part on the EXI grammar 110. The partition function or the partition scanner of the partition module 115 may be configured to perform one or more blocks of the methods 800, 900, 1000, 1100, 1200 described below with reference to FIGS. 8A-12 when executed by the processing device 160.

The partition module 115 may partition one or more of the built-in element grammar 197, the partitioned string table 195, and the partitioned compression 193 by names of elements included in the JSON document 105 as identified by the partition module 115. However, data encoded using JSON may include unnamed portions. In one embodiment, the JSON document 105 may be configured so that each instance where “Object” data type may be used, all the children of the “Object” root are named. The children may include an “Object” type or an “Array” type. Accordingly, the partition module 115 may be configured to partition the built-in element grammar 197, the partitioned string table 195, and the partitioned compression 193 using (1) the name of a closest container (i.e., the closest “Object” or “Array”) and (2) the distance from the closest container. Examples of such partitioning are described below with reference to FIGS. 9B and 10B.

As used herein, the terms “module” or “component” may refer to specific hardware implementations configured to perform the operations of the module or component and/or software objects or software routines that may be stored on and/or executed by the JSON representation system 100. In some embodiments, the different components and modules described herein may be implemented as objects or processes that execute on a computing system (e.g., as separate threads). While some of the system and methods described herein are generally described as being implemented in software (stored on and/or executed by the JSON representation system 100), specific hardware implementations or a combination of software and specific hardware implementations are also possible and contemplated. In this description, a “computing entity” may include any computing system as defined herein, or any module or combination of modules running on a computing system such as the JSON representation system 100.

FIG. 2 illustrates an example built-in element grammar 200 for EXI. The built-in element grammar 200 may be employed, for example, by the EXI processor 125 when decoding the JSON document 105 or encoding the EXI document 130 representing the JSON document 105. The built-in element grammar 200 may include one or more tokens. A token may be an EXI grammar notation. The token may describe different events. For example, the built-in element grammar 200 may include one or more of the following tokens: EE; AT(*); SE(*); and CH. The EE token may correspond to an End Element EXI event type. The AT(*) token may correspond to an Attribute EXI event type. The SE(*) token may correspond to a Start Element EXI event type. The CH token may correspond to a Characters event type.

FIG. 3 illustrates an example invocation of the built-in element grammar 200. The example built-in element grammar 200 was described above with reference to FIG. 2, and that description will not be repeated here. An element 300 depicts an example of the built-in element grammar 200 following an invocation 305 of the SE(*) token included in the built-in element grammar 200. In this example the SE(*) token may be invoked 305 with an element SE(A). The SE(*) token may be depicted with bold lettering in the built-in element grammar 200 to indicate the invocation 305 of the SE(*) token. Referring to the element 300, a new production SE(A) may be inserted at the top of the stack as a consequence of the invocation 305. The SE(A) token may be depicted in bold lettering in the element 300 to indicate a new production resulting from invoking 305 SE(*) with SE(A). The new production SE(A) will be invoked the next time the EXI processor 125 identifies an instance of SE(A). Invoking the SE(A) production may beneficially result in fewer bits to represent the SE token. Accordingly, the description of FIG. 3 describes an example of how the EXI processor may dynamically extend the built-in element grammar 200.

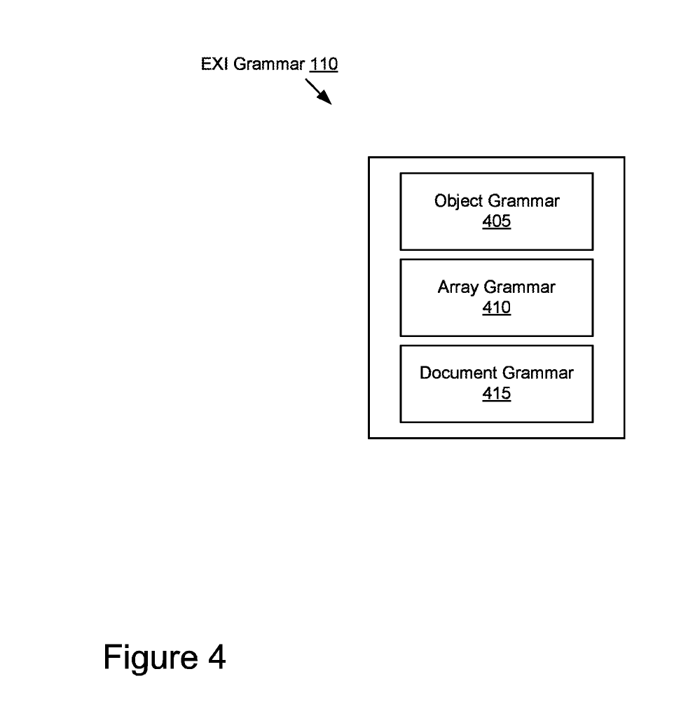

FIG. 4 includes a block diagram of the EXI grammar 110 of FIGS. 1A and 1B for enabling the EXI processor 125 to encode the EXI document 130 representing the JSON document 105. The EXI grammar 110 was described above with reference to FIG. 1, and this description will not be repeated here. In this example, the EXI grammar 110 may include an object grammar 405, an array grammar 410, and a document grammar 415.

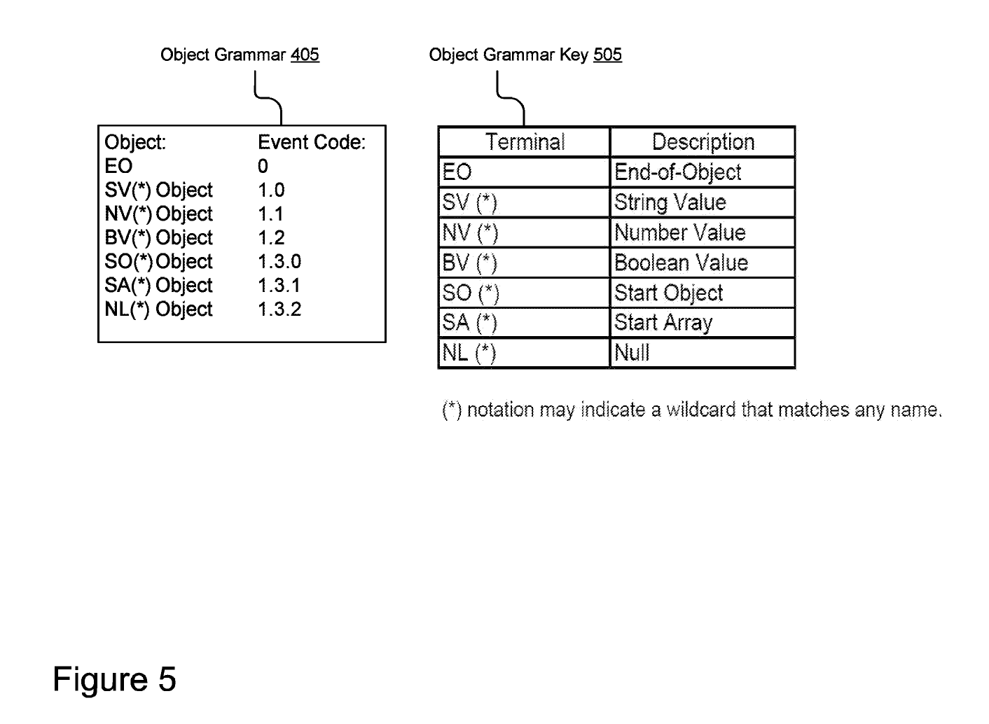

With combined reference to FIGS. 1A, 1B, and 4, the object grammar 405 may include a dynamic grammar describing one or more JSON objects included in the JSON document 105 that may be inputted to the EXI processor 125. There may be one object grammar 405 for each name identified in the JSON document 105. For example, the EXI grammar 110 includes one object grammar 405 for each name included in the JSON document 105. The object grammar 405 is described in more detail below with reference to FIG. 5.

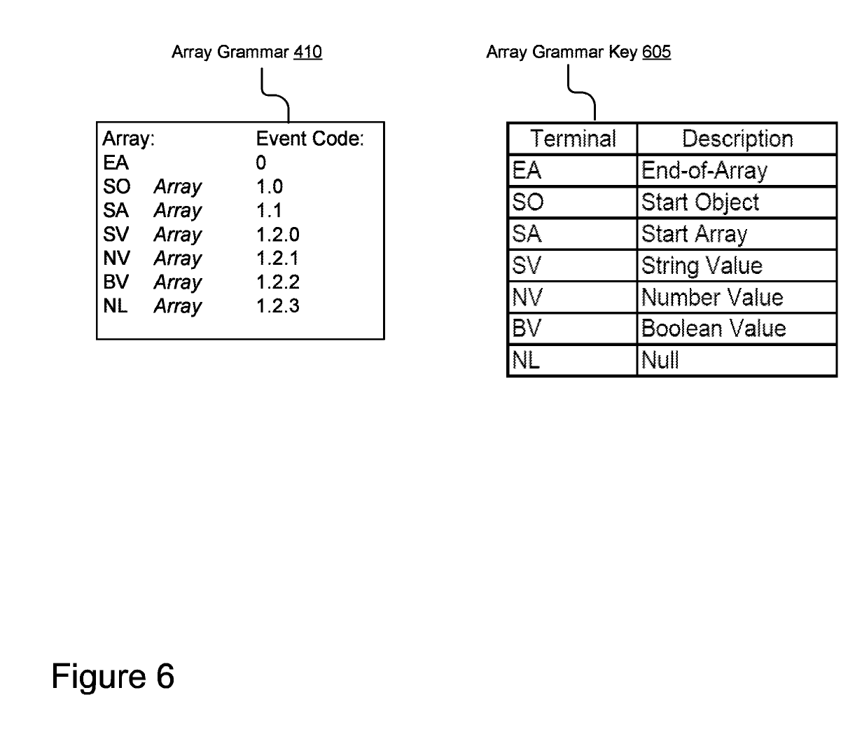

The array grammar 410 may include a dynamic grammar describing one or more JSON arrays included in the JSON document 105 that may be inputted to the EXI processor 125. There may be one array grammar 410 for each name identified in the JSON document 105. For example, the EXI grammar 110 includes one array grammar 410 for each name included in the JSON document 105. The array grammar 410 is described in more detail below with reference to FIG. 6.

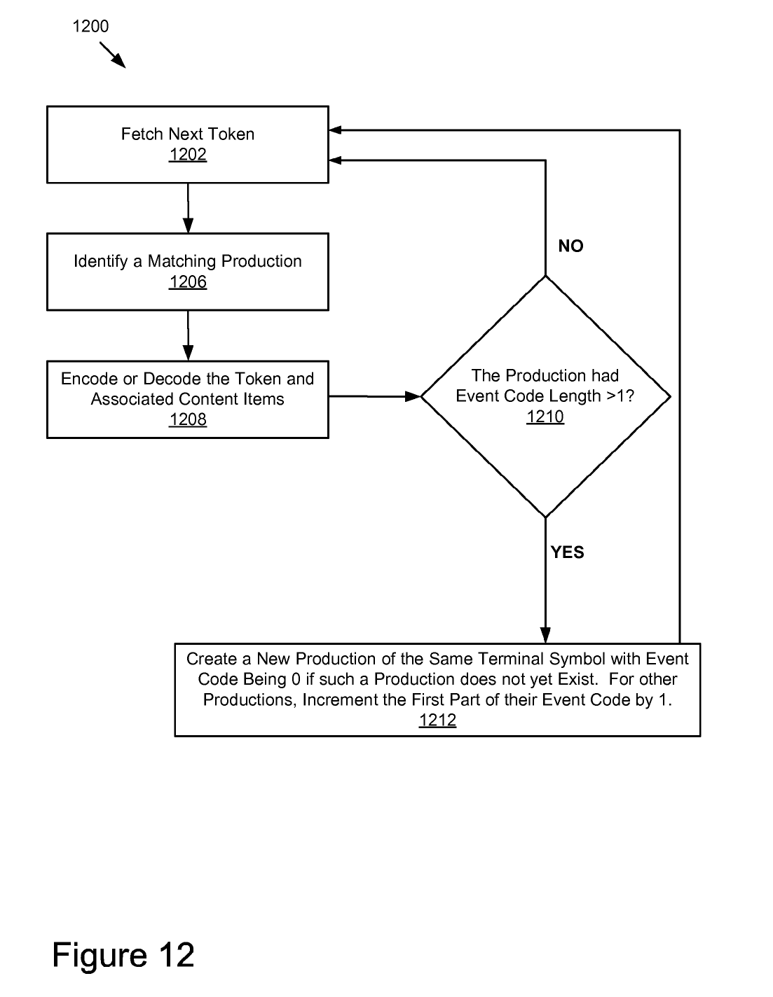

The document grammar 415 may include a static grammar describing the JSON document 105 that may be inputted to the EXI processor 125. The document grammar 415 may include an immutable grammar configured to represent the JSON document 105. The document grammar 415 is described in more detail below with reference to FIG. 12.

FIG. 5 illustrates an embodiment of the object grammar 405 of FIG. 4. The embodiment of the object grammar 405 depicted in FIG. 5 may include the following types of object elements: EO; SV(*) Object; NV(*) Object; BV(*) Object; SO(*) Object; SA(*) Object; and NL(*) Object. An object grammar key 505 may describe the different terminal types included in the object grammar 405. The “(*)” notation may denote a wildcard that matches any object name.

Each object in the object grammar 405 may have a corresponding event code. The combination of the object and the event code may be referred to as a production. For example, the EO Object and corresponding event code “0” form an EO production and the SV(*) object and corresponding event code “1.0” form an SV production.

An event code length for the productions of the object grammar 405 may be determined by the number of numerical characters included in the assigned event code. For example, the event code length for the EO production depicted in the object grammar 405 may be “1” and the event code length for the SV, NV, and BV productions may be “2.” Similarly, the event code length for the SO, SA, and NL productions may be “3.” The EXI processor 125 or the partition module 115 described above with reference to FIGS. 1A and 1B may invoke one or more of the productions included in the object grammar 405.

In one embodiment, invocation of a production included in the object grammar 405 with an event code length larger than “1” (e.g., all productions except for EO as depicted in FIG. 5) may result in one or more of the following steps being executed: (1) a new production with a concrete name may be inserted at the top of the stack with an event code set to “0”; and (2) the remaining event codes in the object grammar 405 may be shifted by one. For example, assume that SO(*) may be invoked with an element SO(A). SO(A) may be moved to the top of the stack with an event code set to “0.” EO may now have an event code set to “1,” SV(*) may now have an event code set to “2.0” and the other productions in the stack may be similarly shifted by one so that the event code for NL(*) may be set to “2.3.2”.

FIG. 6 illustrates an embodiment of the array grammar 410 of FIG. 4. The embodiment of the array grammar 410 depicted in FIG. 6 includes the following types of array elements: EA; SO; SA; SV; NV; BV; and NL. An array grammar key 605 may describe the terminal types included in the array grammar 410.

Each array in the array grammar 410 may have a corresponding event code. The combination of the array and the event code may be referred to as a production. For example, the EA array and corresponding event code “0” form an EA production and the SO array and corresponding event code “1.0” form an SO production.

An event code length for the productions of the array grammar 410 may be determined by the number of numerical characters included in the assigned event code. For example, the event code length for the EA production depicted in the array grammar 410 may be “1” and the event code length for the SO and SA productions may be “2.” Similarly, the event code length for the SV, NV, BV, and NL productions may be “3.” The EXI processor 125 or the partition module 115 described above with reference to FIGS. 1A and 1B may invoke one or more of the productions included in the array grammar 410.

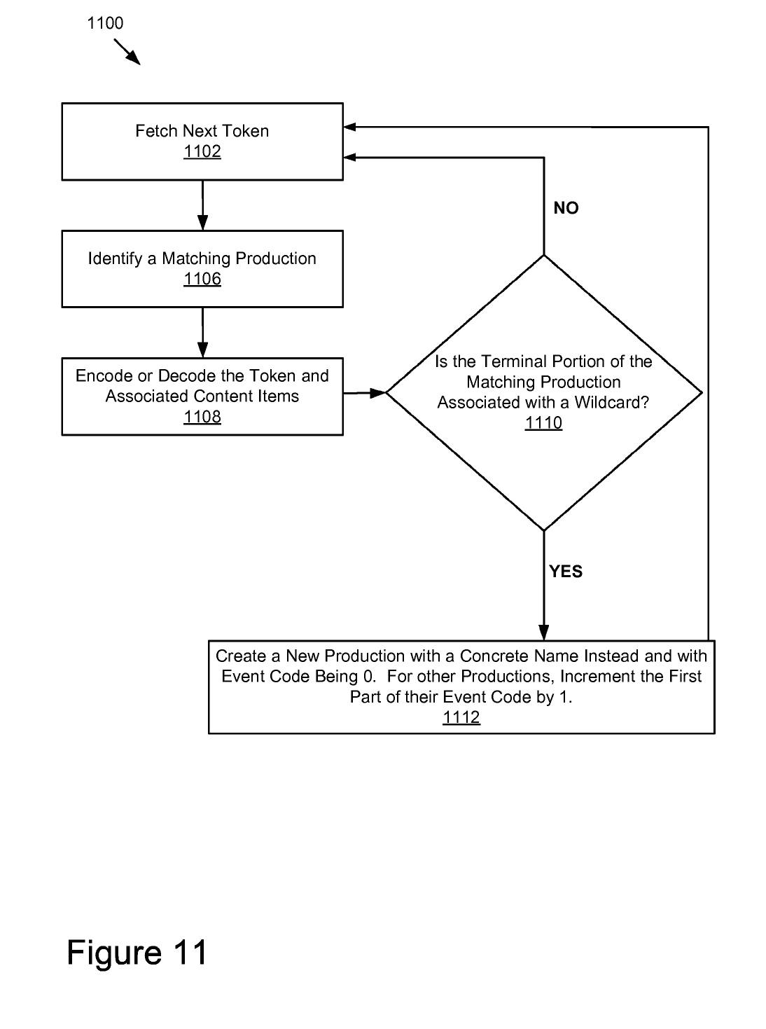

In one embodiment, invocation of a production included in the array grammar 410 with an event code length larger than “1” (e.g., all productions except for EA as depicted in FIG. 11) may result in one or more of the following steps being executed: (1) the same production may be inserted at the top of the stack with an event code set to “0”; and (2) the remaining event codes in the array grammar 410 may be shifted by one. For example, assume that SA may be invoked. SA may be moved to the top of the stack with an event code set to “0.” EA may now have an event code set to “1” and SO may now have an event code set to “2.0” and the other productions in the stack may be similarly shifted by one so that the event code for NL may be set to “2.2.3.”

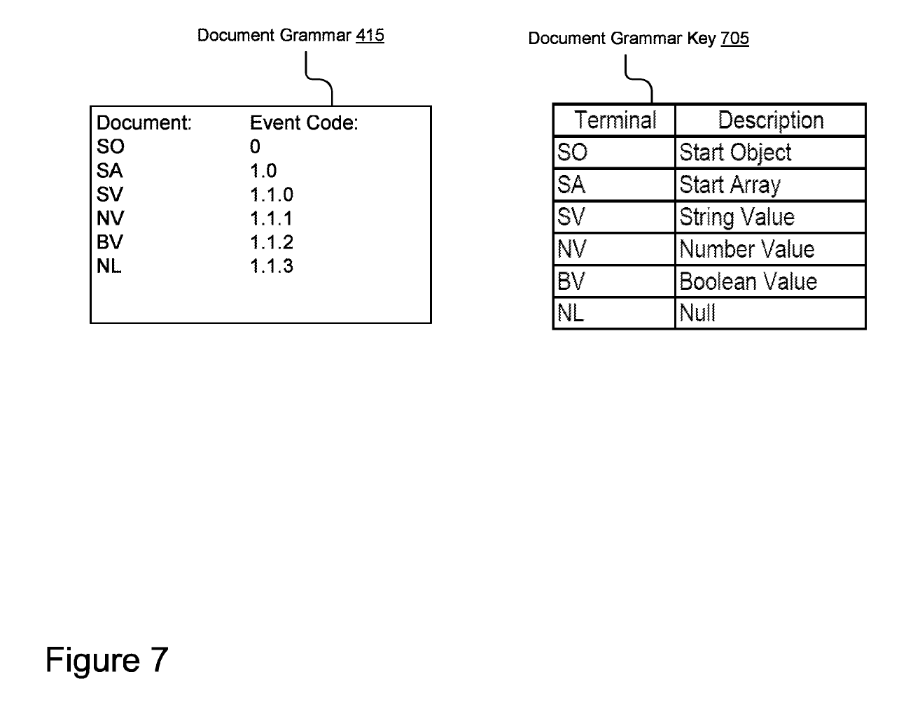

FIG. 7 illustrates an embodiment of the document grammar 415 of FIG. 4. The embodiment of the document grammar 415 depicted in FIG. 7 may include the following types of document elements: SO; SA, SV; NV; BV; and NL. A document grammar key 705 may describe the terminal types included in the document grammar 415.

The document grammar 415 may represent the JSON document 105. In one embodiment, the document grammar 415 may be static and immutable. For example, the document grammar 415 may be unchangeable.

FIGS. 8A-8C show an example flow diagram of the method 800 of determining a current name and a current distance for a token included in the JSON document 105, arranged in accordance with at least one embodiment described herein. Although illustrated as discrete blocks, various blocks may be divided into additional blocks, combined into fewer blocks, or eliminated, depending on the desired implementation. The method 800 may be described below with reference to FIGS. 1A-7.

In some embodiments the method 800 may be performed by a system such as the JSON representation system 100 of FIGS. 1A and 1B. For instance, the processing device 160 of FIG. 1B may be configured to execute computer instructions stored on the memory 170 to perform functions and operations as represented by one or more of the blocks of the method 800 of FIGS. 8A-8C.

The method 800 may be beneficial for determining current names and current distances to portions of the JSON document 105.

The method 800 may begin at block 802. At block 802 a token may be determined or identified by the JSON representation system 100. The token may correspond to a portion or region of the JSON document 105 being inputted to the EXI processor 125 and analyzed by the JSON representation system 100.

At block 804, the JSON representation system 100 may determine whether the token identified at block 802 has a type SV, NV, BV, or NL. For example, a determination is made regarding whether the terminal type for the token is SV, NV, BV, or NL. If the token identified at block 802 has a type SV, NV, BV, or NL, then the method 800 may proceed to block 805.

At block 805 the JSON representation system 100 may determine the current name and distance for the token. For example, the current name and the current distance may be the name and distance stored in the item at the top of the stack, respectively.

At block 806, the JSON representation system 100 may determine that the current name or current distance is unchanged. Tokens of type SV may be further analyzed by the JSON representation system 100 in accordance with the method 900 described below with reference to FIG. 9A.

If at block 804 the JSON representation system 100 determines that the token identified at block 802 is a type other than SV, NV, BV, or NL, then the method 800 may proceed to block 808. At block 808, the JSON representation system 100 may determine whether the token identified at block 802 is type EO or EA. If the token is type EO or EA, then the method 800 may proceed to block 812 depicted on FIG. 8B. The blocks shown on FIG. 8B will be described in more detail below with reference to FIG. 8B.

If the token is a type other than EO or EA at block 808, then the method 800 may proceed to block 810. At block 810 the JSON representation system 100 may determine that the terminal type for the token is SO or SA. The method 800 may proceed to block 818 depicted on FIG. 8C, which is described in more detail below.

Referring now to FIG. 8B, at block 812 a determination may be made regarding whether the token has a given name or is a root. For example, the JSON representation system 100 may determine if the token is associated with a given name or has one or more children.

If at block 812 the JSON representation system 100 determines that the token is unassociated with a given name and is not a root, then the method 800 may move to block 814 and the JSON representation system 100 may decrement the current distance by one. For example, the current name and the current distance may be the name and distance stored in the item at the top of the stack, respectively. At block 814 the current distance may be decremented by one. The current name may remain unchanged while the current distance may be decremented by one.

If at block 812 the JSON representation system 100 determines that the token has a given name or is a root, the method 800 may proceed to block 816. At block 816 the JSON representation system 100 may replace the current name and the current distance by popping from the stack. For example, the current name and the current distance may be the name and distance stored in the item at the top of the stack, respectively. At block 816 the JSON representation system 100 may replace the current name and the current distance by popping from the stack so that a new current name and new current distance is stored in the item at the top of the stack.

Referring now to FIG. 8C, at block 818 a determination may be made regarding whether the token has a given name or is a root. For example, the JSON representation system 100 may determine if the token has a given name associated with it or has one or more children.

If at block 818 the JSON representation system 100 determines that the token is unassociated with a given name or a root, then the method 800 may proceed to block 820. At block 820 the current distance may be incremented by one. For example, the current name and the current distance may be the name and distance stored in the item at the top of the stack, respectively. The current distance may be incremented by one at block 820. In this example the current name may remain unchanged while the current distance may be incremented by one.

If at block 818 the JSON representation system 100 determines that the token has a given name or is a root, the method 800 may proceed to block 822. At block 822 the JSON representation system 100 may replace the current name and the current distance by pushing the current name and the current distance to the stack.

If the token is associated with a given name at block 818, then at block 822 the given name is pushed to the top of the stack to replace the current name and the current distance is set to zero. For example, the current name and the current distance may be the name and distance stored in the item at the top of the stack, respectively. The current name may be replaced by the given name identified at block 818. In this way the given name may be set as the new current name. The distance at the top of the stack may be set to zero. In this way the new current distance may be set to zero.

If the token is a root at block 818, then at block 822 a pseudo name associated with the token is pushed to the top of the stack instead of the given name since no given name may be identified at block 818. The pseudo name may be “_document_” or a similar pseudo name. The current name may be replaced by the pseudo name for the root identified at block 818. In this way the pseudo name may be set as the new current name. The distance at the top of the stack may be set to zero. In this way the new current distance may be set to zero.

FIG. 9A shows an example flow diagram of the method 900 of determining a string-value partition and a value channel for a token included in the JSON document 105, arranged in accordance with at least one embodiment described herein.

At block 902, the JSON representation system 100 may determine that a token is type SV (“String Value”). For example, the terminal type for the token may be SV. At block 904 the JSON representation system 100 may determine if the token has a given name associated with it.

If the token has a given name associated with it, then the method 900 may proceed to block 905. At block 905 the JSON representation system 100 determines that the effective name may be the given name associated with the token as identified at block 904 and the effective distance may be zero. For example, the effective distance is set to zero.

If the token is unassociated with a given name, then the method 900 may proceed to block 906. At block 906 the JSON representation system 100 may determine the current name and the current distance and set the effective name as the current name and the effective distance as the current distance. For example, the current name and the current distance may be the name and distance stored in the item at the top of the stack, respectively. The current name may be set as the effective name and the current distance may be set at the effective distance.

FIG. 9B shows a block diagram of an example system 999 of determining a string-value partition and a value channel. The effective name and the effective distance may be determined as described above with reference to FIG. 9A.

In some embodiments, the effective name and the effective distance determined by the method 900 may serve as an input 908 to a string-value hash table 912. The string-value hash table 912 may be a hash table configured to receive an effective name and an effective distance as the input 908 and provide the string-value partition 916 as an output. For example, the string-value partition 916 may be determined by hashing the effective name and the effective distance determined by the method 900. The string-value partition 916 may be used to determine the partitioned string table 195 described above with reference to FIG. 1B.

In some embodiments, the effective name and the effective distance determined by the method 900 may serve as an input 910 to a value-channel hash table 914. The value-channel hash table 914 may be a hash table configured to receive an effective name and an effective distance as the input 910 and provide the value channel 918 as an output. For example, the value channel 918 may be determined by hashing the effective name and the effective distance determined by the method 900. The value channel 918 may include one or more value content items. Each value content item of the value channel 918 may be encoded based on an associated schema data type. If there is no associated schema data type, then the value content item may be encoded as a string. The value channel 918 may be used to determine the partitioned compression 193 described above with reference to FIG. 1B. For example, the partitioned compression 193 may include an integrated redundancy-based compression partitioned into a channel based on the value channel 918.

In some embodiments, the JSON representation system 100 may encode the EXI document 130 representing the JSON document 105 using one or more of the string-value partition 916 and the value channel 918.

FIG. 10A shows an example flow diagram of the method 1000 of determining an effective name and an effective distance for a token included in the JSON document 105, arranged in accordance with at least one embodiment described herein.

At block 1002, the JSON representation system 100 may determine that a token is type SO (“Start Object”) or SA (“Start Array”). For example, the terminal type for the token may be SO or SA. At block 1004 the JSON representation system 100 may determine that the effective name is the current name and the effective distance is the current distance. For example, the current name and the current distance may be the name and distance stored in the item at the top of the stack, respectively. The current name may be set as the effective name and the current distance may be set at the effective distance.

FIG. 10B shows a block diagram of an example system 1099 of determining an object grammar and an array grammar. The effective name and the effective distance may be determined as described above with reference to FIG. 10A.

In some embodiments where the terminal type may be determined to be SO, the effective name and the effective distance determined by the method 1000 may serve as an input 1008 to an object grammar hash table 1012. The object grammar hash table 1012 may include a hash table configured to receive an effective name and an effective distance as the input 1008 and provide the object grammar 1016 as an output. For example, the object grammar 1016 may be determined by hashing the effective name and the effective distance determined by the method 1000. The object grammar 1016 may include the object grammar 405 as described above with reference to FIGS. 4 and 5. In this way the object grammar 1016 may be determined for each name of the JSON document 105.

In some embodiments where the terminal type may be determined to be SA, the effective name and the effective distance determined by the method 1000 may serve as an input 1010 to an array grammar hash table 1015. The array grammar hash table 1015 may include a hash table configured to receive an effective name and an effective distance as the input 1010 and provide the array grammar 1018 as an output. For example, the array grammar 1018 may be determined by hashing the effective name and the effective distance determined by the method 1000. The array grammar 1018 may include the array grammar 410 as described above with reference to FIGS. 4 and 6. In this way the array grammar 1018 may be determined for each name of the JSON document 105.

In some embodiments, the JSON representation system 100 may encode the EXI document 130 representing the JSON document 105 using one or more of the object grammar 1016 and the array grammar 1018.

FIG. 11 shows an example flow diagram of the method 1100 of providing an object grammar self-calibration, arranged in accordance with at least one embodiment described herein. At block 1102 a token may be fetched. At block 1106 a matching production may be identified. At block 1108 a token and its associated content items may be encoded or decoded. At block 1110, a determination may be made regarding whether a terminal portion of the matching production is associated with a wildcard. If the terminal portion of the matching production is unassociated with a wildcard at block 1110, then the method 1100 may proceed to block 1102 already described above. If the terminal portion of the matching production is associated with a wildcard at block 1110, then the method 1100 may proceed to block 1112. At block 1112, a new production may be created with a concrete name to replace the wildcard and the event code for the production may be set to zero, and the rest of the productions may have the first part of their event codes incremented by one. For example, a production having an event code set to “1.0” may be incremented to “2.0” or a production having an event code set to “1.3.2” may be incremented to “2.3.2”.

FIG. 12 shows an example flow diagram of the method 1200 of providing an array grammar self-calibration, arranged in accordance with at least one embodiment described herein. At block 1202 a token may be fetched. At block 1206 a matching production may be identified. At block 1208 a token and its associated content items may be encoded or decoded. At block 1210, a determination may be made regarding whether the production associated with the production has an event code length greater than or equal to one. If the production has an event code less than one, then the method 1200 may proceed to block 1202 already described above. Otherwise, the method 1200 may proceed to block 1212. At block 1212 a determination may be made regarding whether a production currently exists in the stack that has the same terminal symbol as the token identified in block 1202 with an event code being zero. If such a production does not exist in the stack, then one may be created. If such a production does exist, then the event code for the token identified at block 1202 may be incremented by one.

Some embodiments may include a method of encoding an EXI document to represent a JSON document without use of a binary-type JSON representation solution. The method may include fetching a set of tokens associated with a JSON document. The method may include determining one or more terminal types associated with the set of tokens. The method may include determining one or more current names and one or more current distances for the set of tokens based in part on the terminal type for each of the tokens. The method may include encoding, by a processor-based computing device programmed to perform the encoding, an EXI document representing the JSON document based on the one or more current names and the one or more current distances for the one or more tokens associated with the JSON document.

The embodiments described herein may include the use of a special-purpose or general-purpose computer including various computer hardware or software modules, as discussed in greater detail above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it may be understood that the various changes, substitutions, and alterations could be made hereto without departing from the spirit and scope of the invention.

What is claimed is:

1. A method of encoding an Efficient XML Interchange (EXI) document to represent a JavaScript Object Notation (JSON) document without use of a binary-type JSON representation solution, the method comprising:
fetching a set of tokens associated with a JSON document;
determining one or more terminal types associated with the set of tokens;
determining one or more current names and one or more current distances associated with the set of tokens based in part on the terminal type of the tokens in the set; and
encoding, by a processor-based computing device programmed to perform the encoding, an EXI document representing the JSON document based on the one or more current names and the one or more current distances for the set of tokens associated with the JSON document.

2. The method of claim 1, wherein, responsive to determining that the terminal type for a token in the set is SV, the method further comprises determining if the token is associated with a given name.

3. The method of claim 2, wherein, responsive to determining that the token is unassociated with the given name, the method further comprises:
determining that an effective name for the token is a current name associated with the token;
determining that an effective distance for the token is a current distance associated with the token; and
determining a string-value partition and a value channel by hashing the effective name and the effective distance, wherein the EXI document representing the JSON document is encoded using the string-value partition and the value channel.

4. The method of claim 2, wherein, responsive to determining that the token is associated with the given name, the method further comprises:
determining that a current name associated with the token is the given name;
determining that an effective name for the token is the current name;
setting a current distance associated with the token to zero;
determining that an effective distance for the token is the current distance; and
determining a string-value partition and a value channel by hashing the effective name and the effective distance, wherein the EXI document representing the JSON document is encoded using the string-value partition and the value channel.

5. The method of claim 1, wherein, responsive to determining that the terminal type for a token in the set is SO, the method further comprises:
determining that an effective name for the token is a current name associated with the token;
determining that an effective distance for the token is a current distance associated with the token; and
determining an object grammar based on a hash of the effective name and the effective distance, wherein the EXI document representing the JSON document is encoded using the object grammar.

6. The method of claim 1, wherein, responsive to determining that the terminal type for a token in the set is SA, the method further comprises:
determining that an effective name for the token is a current name associated with the token;
determining that an effective distance for the token is a current distance associated with the token; and
determining an array grammar based on a hash of the effective name and the effective distance, wherein the EXI document representing the JSON document is encoded using the array grammar.

7. The method of claim 1, wherein the EXI document representing the JSON document is encoded using an EXI grammar including an object grammar, an array grammar and a document grammar.

8. The method of claim 7, wherein the object grammar comprises a dynamic grammar that describes one or more objects included in the JSON document that is represented by the EXI document.

9. The method of claim 7, wherein the array grammar comprises a dynamic grammar that describes one or more arrays included in the JSON document that is represented by the EXI document.

10. The method of claim 7, wherein the document grammar comprises a static grammar that describes content of the JSON document that is represented by the EXI document.

11. A non-transitory computer-readable medium having computer instructions stored thereon that are executable by a processing device to perform or control performance of operations comprising:
fetching a set of tokens associated with a JavaScript Object Notation (JSON) document;
determining one or more terminal types associated with the set of tokens;
determining one or more current names and one or more current distances associated with the set of tokens based in part on the terminal type of the tokens in the set; and
encoding, by a processor-based computing device programmed to perform the encoding, an Efficient XML Interchange (EXI) document representing the JSON document based on the one or more current names and the one or more current distances for the set of tokens associated with the JSON document.

12. The non-transitory computer-readable medium of claim 11, wherein, responsive to determining that the terminal type for one of the tokens in the set is SV, the operations further comprise determining if the token is associated with a given name.

13. The non-transitory computer-readable medium of claim 12, wherein, responsive to determining that the token is unassociated with the given name, the operations further comprise:
determining that an effective name for the token is a current name associated with the token;
determining that an effective distance for the token is a current distance associated with the token; and
determining a string-value partition and a value channel by hashing the effective name and the effective distance, wherein the EXI document representing the JSON document is encoded using the string-value partition and the value channel.

14. The non-transitory computer-readable medium of claim 12, wherein, responsive to determining that the token is associated with the given name, the operations further comprise:
determining that an effective name for the token is the given name;
determining that an effective distance for the token is zero; and
determining a string-value partition and a value channel by hashing the effective name and the effective distance, wherein the EXI document representing the JSON document is encoded using the string-value partition and the value channel.

15. The non-transitory computer-readable medium of claim 11, wherein, responsive to determining that the terminal type for a token in the set is SO, the operations further comprise:
determining that an effective name for the token is a current name associated with the token;
determining that an effective distance for the token is a current distance associated with the token; and
determining an object grammar based on a hash of the effective name and the effective distance, wherein the EXI document representing the JSON document is encoded using the object grammar.

16. The non-transitory computer-readable medium of claim 11, wherein, responsive to determining that the terminal type for a token in the set is SA, the operations further comprise:
determining that an effective name for the token is a current name associated with the token;
determining that an effective distance for the token is a current distance associated with the token; and
determining an array grammar based on a hash of the effective name and the effective distance, wherein the EXI document representing the JSON document is encoded using the array grammar.

17. The non-transitory computer-readable medium of claim 11, wherein the EXI document representing the JSON document is encoded using an EXI grammar including an object grammar, an array grammar and a document grammar.

18. The non-transitory computer-readable medium of claim 17, wherein the object grammar comprises a dynamic grammar that describes one or more objects included in the JSON document that is represented by the EXI document.

19. The non-transitory computer-readable medium of claim 17, wherein the array grammar comprises a dynamic grammar that describes one or more arrays included in the JSON document that is represented by the EXI document.

20. The non-transitory computer-readable medium of claim 17, wherein the document grammar comprises a static grammar that describes content of the JSON document that is represented by the EXI document.
